(19) United States
(12) Patent Application Publication
(10) Pub. No.: US 2026/0154310 A1
(43) Pub. Date: Jun. 4, 2026

(54) INCIDENT RESPONSE SUPPORT METHOD AND INCIDENT RESPONSE SUPPORT SYSTEM

(71) Applicant: Hitachi, Ltd., Tokyo (JP)

(72) Inventors: Kiyomi WADA, Tokyo (JP); Mineyoshi MASUDA, Tokyo (JP)

(21) Appl. No.: 19/304,994

(22) Filed: Aug. 20, 2025

(30) Foreign Application Priority Data
Dec. 4, 2024 (JP) 2024-211830

(51) Int. Cl. G06F 16/334; G06F 16/35

(52) U.S. Cl. CPC G06F 16/3344; G06F 16/35

(57) ABSTRACT

An incident response support system searches for the past case information based on a symptom and system information of the target system as an input of a natural language using a language model for generating an output in response to the input, and acquire the past case in which the symptom and the system information are coincident or similar. Then, the incident response support system groups the past case by the separation action included in the acquired past case using the language model, and outputs the grouped past case together with the separation action.

### CROSS-REFERENCE TO RELATED APPLICATION

The present application claims priority from Japanese application JP 2024-211830, filed on Dec. 4, 2024, the content of which is hereby incorporated by reference into this application.

### BACKGROUND OF THE INVENTION

### 1. Field of the Invention

The present invention relates to an incident response support method and an incident response support system.

### 2. Description of Related Art

In the related art, when a system failure occurs in an IT service, an expert of operation of the IT service uses know-how based on his or her own experience to identify a cause of the failure and take countermeasures to restore the system. On the other hand, there is a need to convert such insight of the expert into knowledge such that even a user who is not an expert can identify a cause, take countermeasures, and perform restoration by utilizing the knowledge at the time of a system failure.

Regarding the cause identification utilizing the knowledge, for example, Patent Literature 1 discloses the following related art. That is, a query for searching for a solution to the system failure is classified into an intention of the query based on a text expression thereof, and a solution to the system failure in the past is mapped to each query based on the intention, so that the solution is converted into knowledge. Then, a symptom of an input system failure is converted into a query, and a solution is searched for using the converted query.

### CITATION LIST

### Patent Literature

PTL 1: US2023/0394038

### SUMMARY OF THE INVENTION

However, in the related art described above, when the symptom of the system failure is converted into a query, in a case where information necessary for the search is not sufficiently captured, the symptom is not converted into an appropriate query, and search accuracy of the solution is reduced, so that an appropriate solution cannot be obtained. However, inputting a large amount of information in order to cover the information necessary for the search is a heavy burden on the user.

The present invention has been made in view of the above-described problems, and an object of the present invention is to obtain an appropriate solution to a system failure without requiring a burden even for a user who is not an expert.

In order to achieve the object described above, an aspect of the present invention provides an incident response support method executed by an incident response support system that supports identification of a cause of an incident occurred in a target system, the incident response support system being configured to access separation action information in which a combination of a confirmation procedure executed for the target system for identifying a cause of the incident, the cause, and a countermeasure against the incident is stored as a separation action, and past case information in which a combination of a symptom of an incident occurred in a past system, system information indicating a configuration of the past system, and the separation action including the confirmation procedure executed for the past system in which the incident occurred is stored as a past case, and the incident response support method including: respective processes of a processor of the incident response support system searching for the past case information based on a symptom and system information of the target system as an input of a natural language using a language model for generating an output in response to the input, and acquiring the past case in which the symptom and the system information are coincident or similar; grouping the past case by the separation action included in the acquired past case using the language model; and outputting the grouped past case together with the separation action.

According to the present invention, for example, even a user who is not an expert can obtain an appropriate solution to a system failure without requiring a burden.

### BRIEF DESCRIPTION OF THE DRAWINGS

FIG. 1 is a diagram for illustrating an outline of an embodiment.

FIG. 2 is a diagram illustrating a configuration of an entire system including an incident response support system according to the embodiment.

FIG. 3 is a diagram illustrating a configuration of the incident response support system according to the embodiment.

FIG. 4 is a diagram illustrating a configuration of a prompt information table according to the embodiment.

FIG. 5 is a diagram illustrating a configuration of a search query according to the embodiment.

FIG. 6 is a diagram illustrating a configuration of a ticket management server according to the embodiment.

FIG. 7 is a diagram illustrating a configuration of a ticket information table according to the embodiment.

FIG. 8 is a diagram illustrating a configuration of a work memo table according to the embodiment.

FIG. 9 is a diagram illustrating a configuration of a knowledge DB server according to the embodiment.

FIG. 10 is a diagram illustrating a configuration of an FAQ according to the embodiment.

FIG. 11 is a diagram illustrating a configuration of a separation action table according to the embodiment.

FIG. 12 is a diagram illustrating a configuration of a user terminal according to the embodiment.

FIG. 13 is a flowchart illustrating an FAQ creation and update process according to the embodiment.

FIG. 14 is a flowchart illustrating an FAQ search process according to the embodiment.

FIG. 15 is a diagram illustrating a configuration of an incident response support screen according to the embodiment.

FIG. 16 is a diagram for illustrating an outline of an FAQ creation process according to the embodiment.

FIG. 17 is a diagram for illustrating an outline of the FAQ search process according to the embodiment.

FIG. 18 is a diagram for illustrating an outline of an FAQ update process according to the embodiment.

### DESCRIPTION OF EMBODIMENTS

In the following description, a “processor” may be one or more processor devices. At least one processor device may typically be a micro-processor device such as a central processing unit (CPU), and may also be another type of processor device such as a graphics processing unit (GPU). At least one processor device may be a single core or a multicore. At least one processor device may be a processor core. At least one processor device may be a processor device in a broad sense, such as a hardware circuit (for example, field-programmable gate array (FPGA), complex programmable logic device (CPLD), or application specific integrated circuit (ASIC)) that performs a part or the entire of a process.

In the following description, a process may be described using a “XXX processing unit” as a subject. However, the XXX processing unit is to perform a predetermined process appropriately using a storage device and/or an interface device by executing a program by a processor. Therefore, the subject of the process may be the processor (or a device such as a controller having the processor). The program may be installed on a device such as a computer from a program source. Here, the program source may be, for example, a program distribution server or a computer-readable (for example, non-transitory) recording medium. Further, in the following description, two or more programs may be implemented as one program, or one program may be implemented as two or more programs.

In the following description, information from which an output is obtained in response to an input may be described using an expression such as a “xxx table”. However, the information may be data of any structure (for example, may be structured data or unstructured data), or may be a learning model represented by a neural network, a genetic algorithm, or a random forest that generates the output in response to the input. Therefore, the “xxx table” can be referred to as “xxx information”. Further, in the following description, a configuration of each table is an example, and one table may be divided into two or more tables, or all or a part of two or more tables may be one table.

### Overview of Embodiments

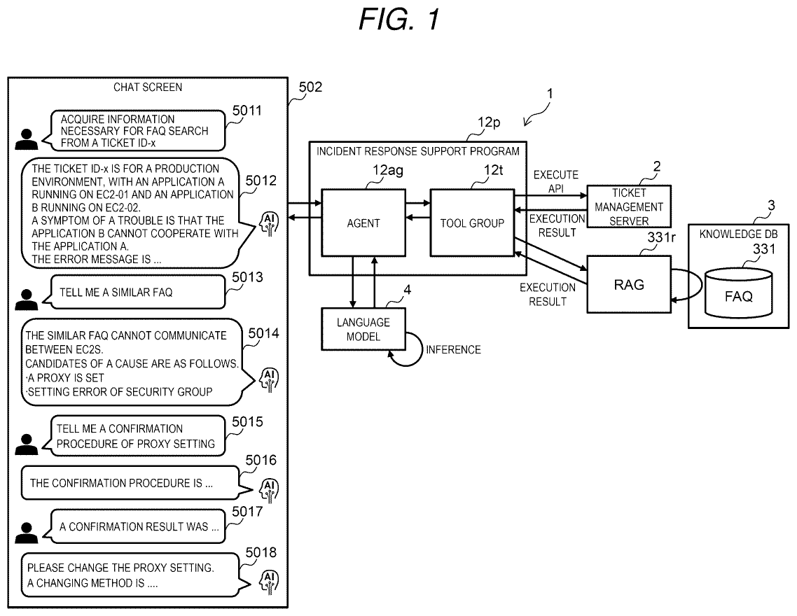

FIG. 1 is a diagram for illustrating an overview of an embodiment. An incident response support system 1 presents, to a user through exchange such as chat, a confirmation procedure, a cause, and a countermeasure for an incident occurred in an execution environment of a target system that executes a service.

The incident response support system 1 executes an incident response support program 12p. The incident response support program 12p includes an agent 12ag and a tool group 12t in addition to a processing function unit that executes each process related to an incident response support process to be described later.

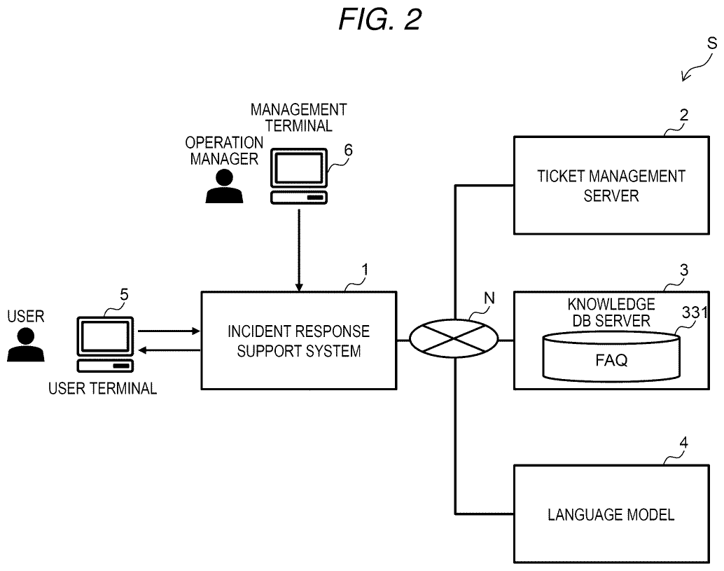

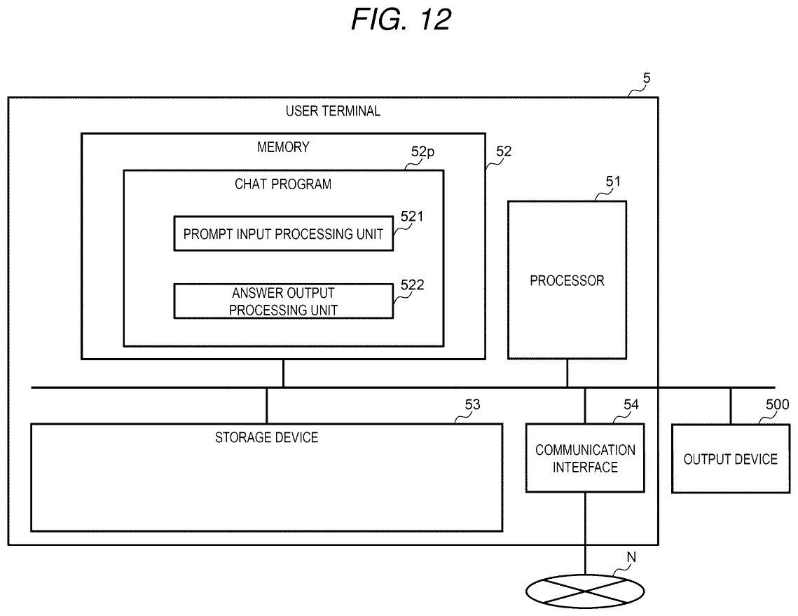

The agent 12ag interprets a chat input from a chat screen 502 displayed in an output device 500 (FIG. 12) connected to a user terminal 5 (FIG. 2) to be described later. The agent 12ag makes an inquiry to a language model 4 or requests the tool group 12t to perform a necessary process according to the interpretation of the chat. In addition, the agent 12ag outputs an inquiry result returned from the language model 4 and a processing result of the process executed by the tool group 12t to the chat screen 502 as a chat.

The language model 4 is a model such as large language models (LLM) constructed by learning a large amount of text data, and is, for example, a generative artificial intelligence (AI) that generates an output desired by a user in response to an input of the user and outputs the output. The input and output referred to herein are texts, images, audio, music, animations, and the like in a natural language.

The tool group 12t provides tools such as an application programming interface (API) for accessing an external device such as a ticket management server 2 and a retrieval-augmented generation (RAG) that provides a function of adding a search result of external information to an inquiry to the language model 4. The tool group 12t selects an appropriate tool in response to the request from the agent 12ag, and executes a target process using the selected tool.

Specifically, the tool group 12t executes an API for acquiring ticket information with respect to the ticket management server 2 in response to the request from the agent 12ag. Then, the tool group 12t returns the acquired ticket information to the agent 12ag as an execution result.

The tool group 12t inquires an RAG system 331r of information related to the inquiry to the language model 4 from the agent 12ag, and acquires a search result obtained by searching frequently asked questions (FAQ) 331 of a knowledge data base (DB) 3 from the RAG system 331r. The agent 12ag adds the search result of a FAQ table 331 acquired from the RAG system 331r and makes an inquiry to the language model 4.

For example, a chat 5011 input to the chat screen 502 is a request for acquiring information necessary for an FAQ search from a ticket by the user designating a ticket ID. The agent 12ag interprets the chat 5011, and requests the tool group 12t to refer to the ticket management server 2, acquire the ticket of the designated ticket ID, and acquire the information necessary for the FAQ search. A chat 5012 output to the chat screen 502 is information acquired by the tool group 12t in accordance with the chat 5011.

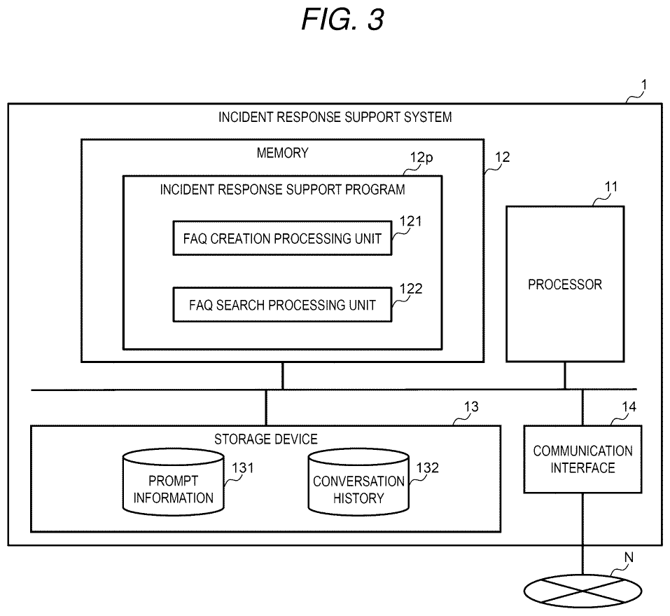

The chat 5013 input to the chat screen 502 is a request for a similar FAQ similar to the FAQ shown in the chat 5012. The agent 12ag interprets the chat 5013, and requests the tool group 12t to search the FAQ table 331 of the knowledge DB server 3 via the RAG system 331r, and acquire the similar FAQ. When searching for the similar FAQ, the RAG system 331r adds additional information based on a conversation history 132 (FIG. 3) of the input and output of the chat screen 502 to the input. The history of the input and output of the chat screen 502 is recorded by the incident response support program 12p. Accordingly, search accuracy for the similar FAQ can be improved.

A chat 5014 output to the chat screen 502 is a similar FAQ acquired by the tool group 12t in accordance with the chat 5013.

The chat 5015 input to the chat screen 502 is an inquiry about a “confirmation procedure of a proxy setting” by the user about the information indicated in the chat 5014. The agent 12ag interprets the chat 5015, inquires the language model 4 about the “confirmation procedure of a proxy setting”, and acquires an inquiry result.

The chat 5016 output to the chat screen 502 is the “confirmation procedure of a proxy setting” acquired by inquiring the language model 4 in accordance with the chat 5015.

The chat 5017 input to the chat screen 502 is an execution result (confirmation result) input by the user actually executing the “confirmation procedure of a proxy setting” indicated in the chat 5016. The agent 12ag interprets the chat 5017 and acquires a countermeasure corresponding to the confirmation result. The chat 5018 output to the chat screen 502 is a countermeasure acquired in accordance with the chat 5017.

### System Configuration According to Embodiment

FIG. 2 is a diagram illustrating a configuration of an overall system S including the incident response support system 1 according to the embodiment.

The overall system S includes the incident response support system 1, the ticket management server 2, the knowledge DB server 3, the language model 4, the user terminal 5, and a management terminal 6. The incident response support system 1, the ticket management server 2, the knowledge DB server 3, and the language model 4 can communicate with other devices via a network N.

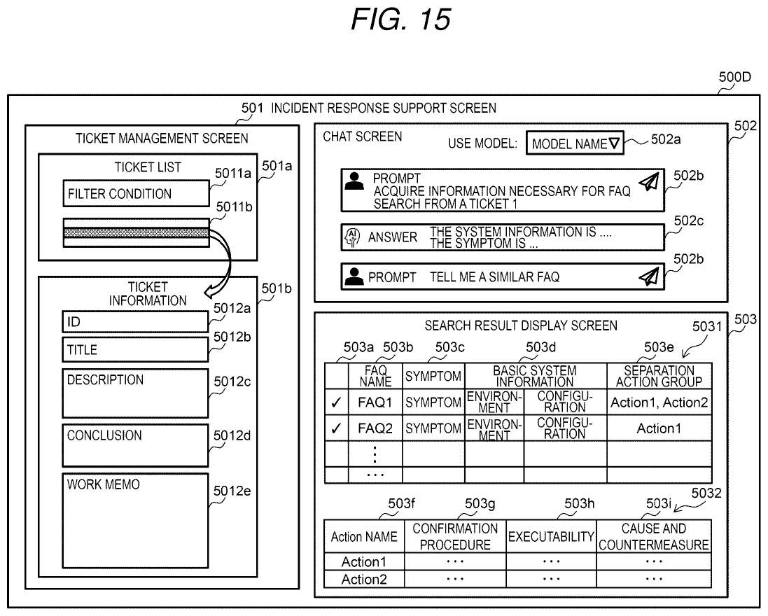

The user terminal 5 and the management terminal 6 are connected to the incident response support system 1. The user terminal 5 is a terminal of a user who receives an incident response support. The user receives the incident response support by the incident response support system 1 by inputting and outputting information via an incident response support screen 500D (FIG. 15) to be described later displayed on the user terminal 5. The management terminal 6 is a terminal of an operation manager in charge of operation management of the incident response support system 1.

### Configuration of Incident Response Support System 1 According to Embodiment

FIG. 3 is a diagram illustrating a configuration of the incident response support system 1 according to the embodiment. The incident response support system 1 includes a processor 11, a memory 12, a storage device 13, and a communication interface 14.

The memory 12 stores and executes the incident response support program 12p loaded from the storage device 13 or the like by the processor 11. The incident response support program 12p includes an FAQ creation processing unit 121 and an FAQ search processing unit 122. Processes of the FAQ creation processing unit 121 and the FAQ search processing unit 122 will be described later.

The storage device 13 is a non-volatile storage unit that stores a prompt information table 131 and the conversation history 132. Details of the prompt information table 131 will be described later. The conversation history 132 is a chat history between the user and the agent 12ag via the chat screen 502.

The communication interface 14 is a communication device for the incident response support system 1 to communicate with an external device via the network N.

### Configuration of Prompt Information Table 131 According to Embodiment

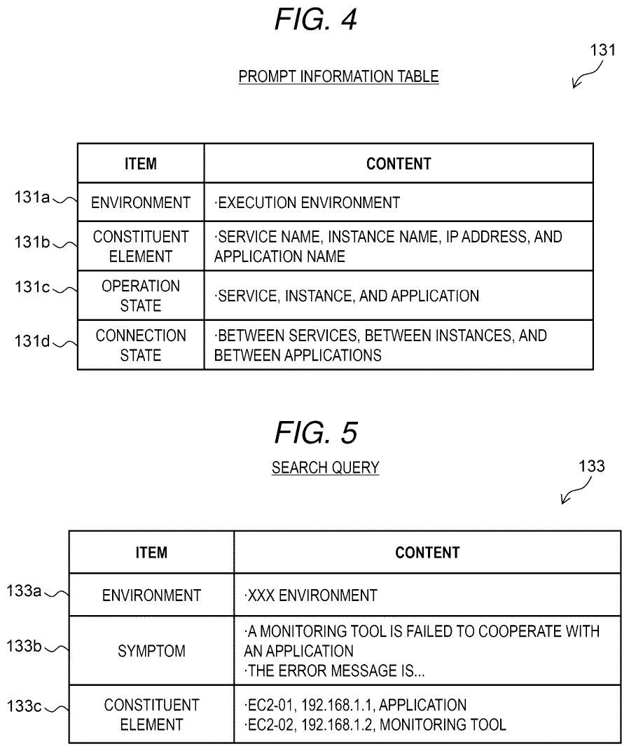

FIG. 4 is a diagram illustrating a configuration of the prompt information table 131 according to the embodiment. The prompt information table 131 is information in which essential items of a prompt 502b used for searching the FAQ table 331 of the knowledge DB server 3 are listed. The prompt information table 131 includes items of an environment 131a, a constituent element 131b, an operation state 131c, and a connection state 131d.

The environment 131a has a content of “execution environment” and represents an execution environment of a service in which an incident has occurred. The constituent element 131b has a content of “service name, instance name, IP address, and application name”, and lists constituent elements of the execution environment of the service in which the incident has occurred. The operation state 131c has a content of “service, instance, and application”, and indicates an operation state of each constituent element of the execution environment of the service in which the incident has occurred. The connection state 131d has a content of “between services, between instances, and between applications”, and indicates a connection state between respective constituent elements of the execution environment of the service in which the incident has occurred.

### Configuration of Search Query 133 According to Embodiment

FIG. 5 is a diagram illustrating a configuration of a search query 133 according to the embodiment. The search query 133 is a query used for searching the FAQ table 331 of the knowledge DB server 3. The search query 133 includes items of an environment 133a, a symptom 133b, and a constituent element 133c. The environment 133a has a content of “xxx environment”, and represents a specific name of the execution environment of the service in which the incident has occurred. The symptom 133b has a content of “a monitoring tool is failed to cooperate with an application” and “the error message is . . . ”, and specifically represents a symptom when the incident has occurred. The constituent element 133c has a content of “EC2-01, 192.168.1.1, application”, “EC2-02, 192.168.1.2, monitoring tool”, and the like, and specifically lists constituent elements (service, instance, IP address, and application) of the execution environment of the service in which the incident has occurred.

### Configuration of Ticket Management Server 2 According to Embodiment

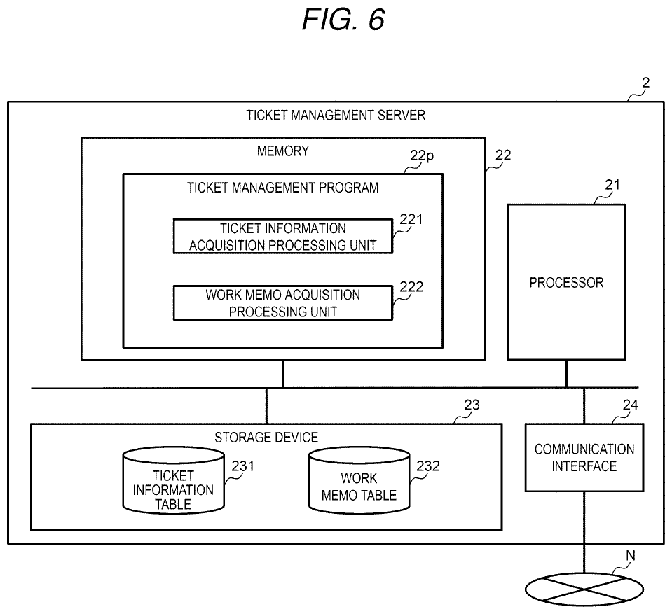

FIG. 6 is a diagram illustrating a configuration of the ticket management server 2 according to the embodiment. The ticket management server 2 includes a processor 21, a memory 22, a storage device 23, and a communication interface 24.

The memory 22 stores and executes a ticket management program 22p loaded from the storage device 23 or the like by the processor 21. The ticket management program 22p includes a ticket information acquisition processing unit 221 and a work memo acquisition processing unit 222. Processes of the ticket information acquisition processing unit 221 and the work memo acquisition processing unit 222 will be described later.

The storage device 23 is a non-volatile storage unit that stores a ticket information table 231 and a work memo table 232. Details of the ticket information table 231 and the work memo table 232 will be described later.

The communication interface 24 is a communication device for the ticket management server 2 to communicate with an external device via the network N.

### Configuration of Ticket Information Table 231 According to Embodiment

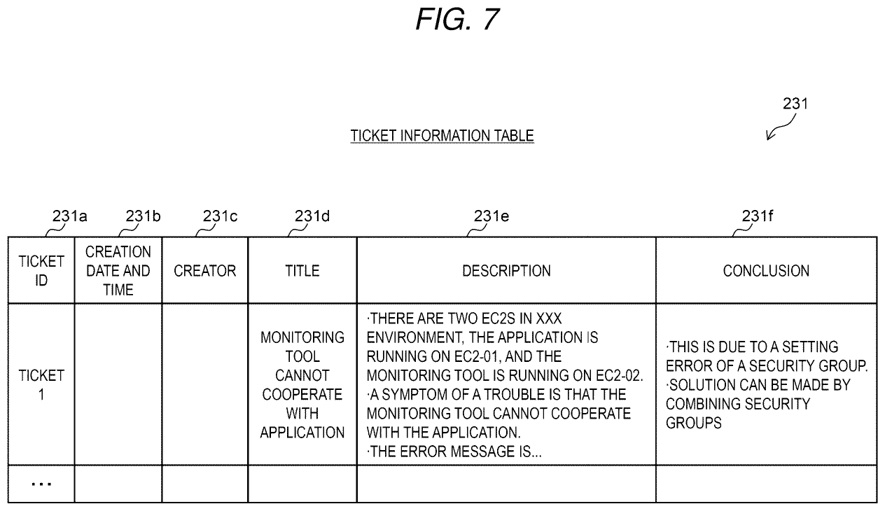

FIG. 7 is a diagram illustrating a configuration of the ticket information table 231 according to the embodiment. The ticket information table 231 manages information for managing incidents that have occurred in a system in which a target service managed by the ticket management server 2 is executed. The ticket information table 231 manages information extracted from the work memo table 232. The ticket information table 231 includes items of a ticket ID 231a, a creation date and time 231b, a creator 231c, a title 231d, a description 231e, and a conclusion 231f.

The ticket ID 231a is identification information of a corresponding ticket. The creation date and time 231b is a creation date and time of the corresponding ticket. The creator 231c indicates a creator of the corresponding ticket. The title 231d is a title of the corresponding ticket and represents an outline of the incident. The description 231e is a content of the corresponding ticket (such as content according to items shown in prompt information table 131). The conclusion 231f indicates a cause, a countermeasure, and whether the incident is finally solved of the incident indicated by the corresponding ticket.

When the incident occurs, the ticket ID 231a, the creation date and time 231b, the creator 231c, the title 231d, and the description 231e are input. When the incident is solved, the conclusion 231f is input.

### Configuration of Work Memo Table 232 According to Embodiment

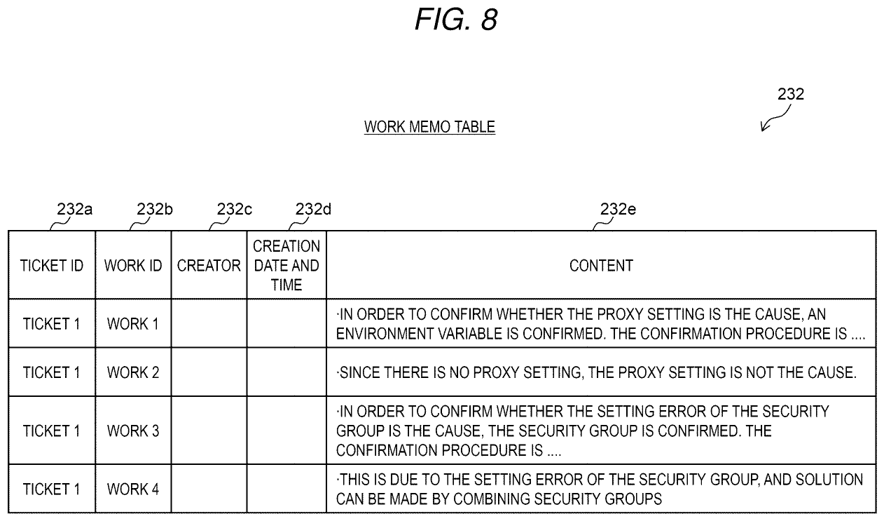

FIG. 8 is a diagram illustrating a configuration of the work memo table 232 according to the embodiment. The work memo table 232 is an example of a work record, and is a response and a response result recorded by a worker at the time of response to the incident. The work memo table 232 includes items of a ticket ID 232a, a work ID 232b, a creator 232c, a creation date and time 232d, and a content 232e.

The ticket ID 232a is identification information of a ticket which is an extraction source of a corresponding work memo. The work ID 232b is identification information of a work in which the corresponding work memo is recorded. The creator 232c indicates a creator of the corresponding work memo. The creation date and time 232d indicates a creation date and time of the corresponding work memo. The content 232e is an entity of the corresponding work memo.

### Configuration of Knowledge DB Server 3 According to Embodiment

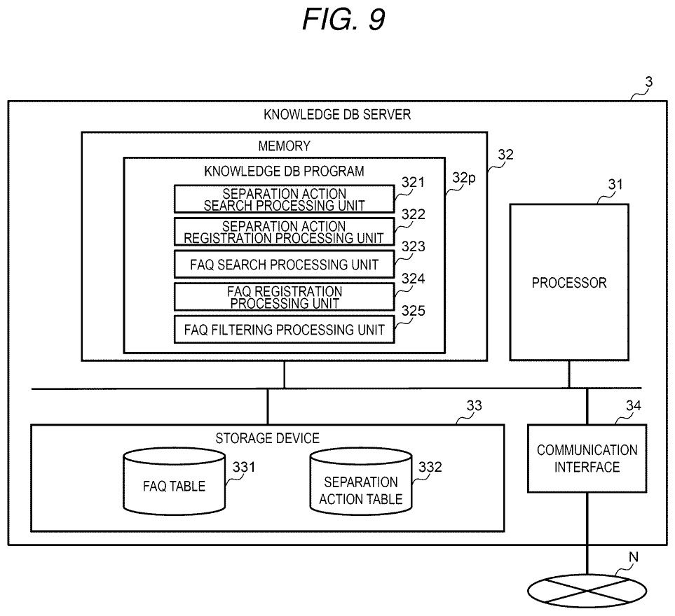

FIG. 9 is a diagram illustrating a configuration of the knowledge DB server 3 according to the embodiment. The knowledge DB server 3 includes a processor 31, a memory 32, a storage device 33, and a communication interface 34.

The memory 32 stores and executes a knowledge DB program 32p loaded from the storage device 33 or the like by the processor 31. The knowledge DB program 32p includes a separation action search processing unit 321, a separation action registration processing unit 322, an FAQ search processing unit 323, an FAQ registration processing unit 324, and an FAQ filtering processing unit 325. Processes of the separation action search processing unit 321, the separation action registration processing unit 322, the FAQ search processing unit 323, the FAQ registration processing unit 324, and the FAQ filtering processing unit 325 will be described later.

The storage device 33 is a non-volatile storage unit that stores the FAQ table 331 and the separation action table 332. Details of the FAQ table 331 and the separation action table 332 will be described later.

The communication interface 34 is a communication device for the knowledge DB server 3 to communicate with an external device via the network N.

### Configuration of FAQ Table 331 According to Embodiment

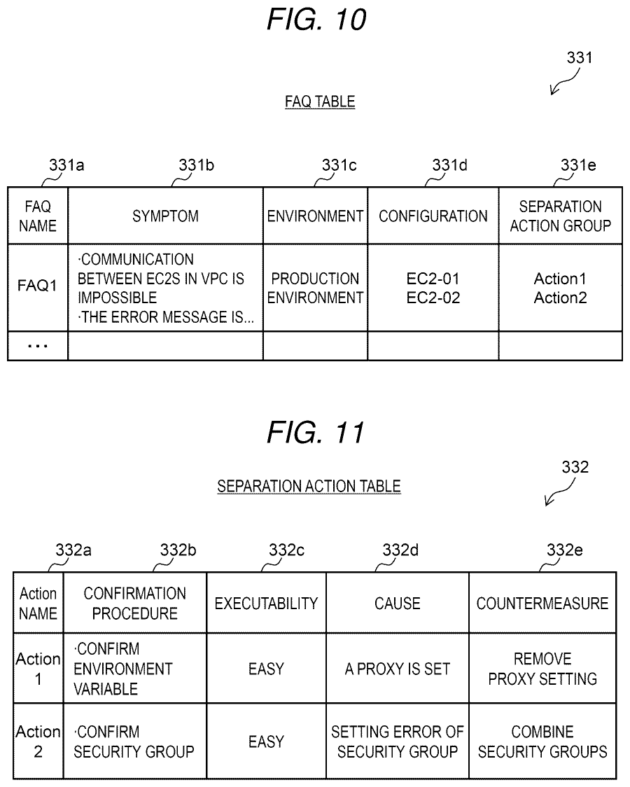

FIG. 10 is a diagram illustrating a configuration of the FAQ table 331 according to the embodiment. The FAQ table 331 is information indicating correspondence between symptoms corresponding to an FAQ in a system that executes a target service and separation actions. The FAQ table 331 includes items of an FAQ name 331a, a symptom 331b, an environment 331c, a configuration 331d, and a separation action group 331e. The FAQ in which the FAQ name 331a, the symptom 331b, the environment 331c, the configuration 331d, and the separation action group 331e are associated with each other is an example of a past case. In addition, the FAQ table 331 is an example of past case information.

The FAQ name 331a is a name or identification information of a corresponding FAQ. The symptom 331b indicates a symptom corresponding to the corresponding FAQ. The environment 331c indicates an environment in which the corresponding symptom has occurred. The configuration 331d indicates a constituent element of the system in which the corresponding symptom has occurred. The separation action group 331e indicates a group of one or a plurality of separation actions to which the corresponding FAQ corresponds. The separation action includes reference to configuration information, a result of command execution, reference to a log or trace, and confirmation of a graphical user interface (GUI).

### Configuration of Separation Action Table 332 According to Embodiment

FIG. 11 is a diagram illustrating a configuration of the separation action table 332 according to the embodiment. The separation action table 332 is information indicating a separation action group indicated by a correspondence among a confirmation procedure, a cause, and a countermeasure for grouping the FAQ in the system that executes the target service. The separation action table 332 includes items of an Action name 332a, a confirmation procedure 332b, executability 332c, a cause 332d, and a countermeasure 332e. The separation action table 332 is an example of separation action information.

The Action name 332a is a name of a corresponding separation action group and is identification information. The confirmation procedure 332b indicates a method of confirming whether an incident to be investigated has occurred due to the cause 332d of the corresponding separation action group. The executability 332c is an index indicating executability of the corresponding confirmation procedure 332b. The cause 332d indicates a cause of occurrence of an incident grouped into the corresponding action group. The countermeasure 332e indicates a countermeasure for performing the incident grouped into the corresponding action group to restore the system.

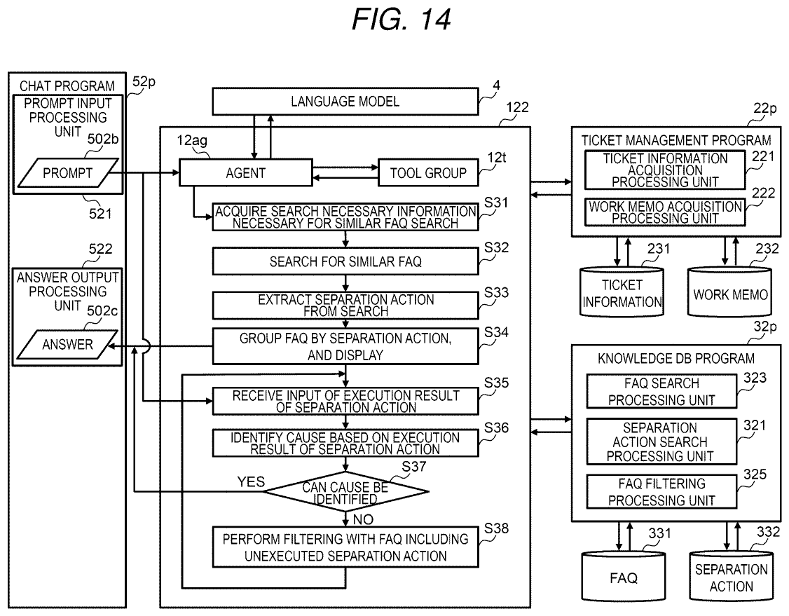

In addition to or instead of the executability 332c, the separation action table 332 may include ranking in descending order of the symptoms 331b associated in the FAQ table 331. In step S35 (FIG. 14) of an FAQ search process to be described later, an input of an execution result of a separation action having the largest number of associated symptoms 331b is received.

### Configuration of User Terminal 5 According to Embodiment

FIG. 12 is a diagram illustrating a configuration of the user terminal 5 according to the embodiment. The user terminal 5 includes a processor 51, a memory 52, a storage device 53, and a communication interface 54. In addition, the output device 500 such as a display and an input device (not illustrated) such as a keyboard are connected to the user terminal 5 via a predetermined interface.

The memory 52 stores and executes a chat program 52p loaded from the storage device 53 or the like by the processor 51. The chat program 52p includes a prompt input processing unit 521 and an answer output processing unit 522. Processes of the prompt input processing unit 521 and the answer output processing unit 522 will be described later.

The storage device 53 is a non-volatile storage unit. The communication interface 54 is a communication device for the user terminal 5 to communicate with an external device via the network N.

### FAQ Creation and Update Process According to Embodiment

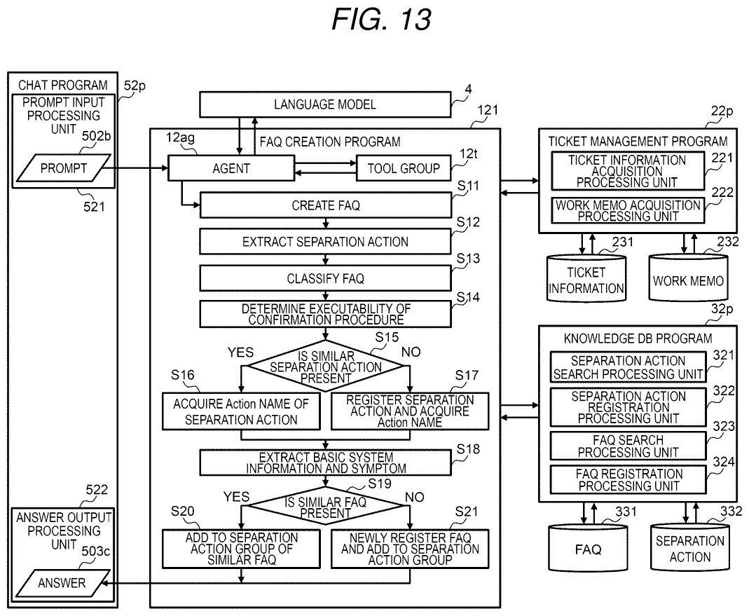

FIG. 13 is a flowchart illustrating an FAQ creation and update process according to the embodiment. The FAQ creation and update process is executed by the FAQ creation processing unit 121 of the incident response support system 1 when the user who operates the user terminal 5 inputs the prompt 502b.

First, in step S11, the FAQ creation processing unit 121 of the incident response support system 1 creates an FAQ.

That is, the prompt input processing unit 521 of the chat program 52p transmits the prompt 502b for requesting FAQ creation input by the user via the chat screen 502 to the incident response support system 1.

The agent 12ag of the incident response support system 1 interprets the prompt 502b received from the chat program 52p and requests the tool group 12t to acquire a designated ticket.

The tool group 12t requests the ticket management program 22p to acquire the designated ticket. The ticket information acquisition processing unit 221 and the work memo acquisition processing unit 222 of the ticket management program 22p acquire the ticket stored in the ticket information table 231 in response to the request from the tool group 12t. In addition, the ticket information acquisition processing unit 221 and the work memo acquisition processing unit 222 acquire a work memo associated with the acquired ticket from the work memo table 232. Then, the ticket information acquisition processing unit 221 and the work memo acquisition processing unit 222 transmit the acquired ticket and work memo to the tool group 12t. The tool group 12t transmits the work memo table 232 and the ticket received from the ticket management program 22p to the agent 12ag. The agent 12ag creates an FAQ based on the received ticket+work memo using the language model 4. The FAQ includes items of symptom, system information, confirmation procedure, and cause and countermeasure.

Next, in step S12, the FAQ creation processing unit 121 uses the language model 4 to extract, from the FAQ created in step S11, a separation action (confirmation procedure and combination of cause and countermeasure) for identifying the cause. The separation action is extracted by excluding duplication due to coincidence or similarity regarding the confirmation procedure and the cause and countermeasure of the FAQ acquired in step S11 using the language model 4.

Next, in step S13, the FAQ creation processing unit 121 uses the language model 4 to classify the confirmation procedure and the cause and countermeasure of the FAQ created in step S11 for each separation action based on the coincidence or similarity. Next, in step S14, the FAQ creation processing unit 121 uses the language model 4 to parameterize a constant included in the confirmation procedure classified in step S13, and determines the executability. The executability may be evaluated based on an amount of labor of the user required for execution, and for example, the executability is evaluated as “easy” for those that can be easily executed using a tool or the like, and “difficult” for other cases.

Next, in step S15, the FAQ creation processing unit 121 determines whether a separation action that is coincident or similar to the separation action extracted in step S12 is registered in the separation action table 332 of the knowledge DB server 3.

That is, the FAQ creation processing unit 121 requests the separation action search processing unit 321 of the knowledge DB program 32p to search for the separation action that is coincident or similar to the separation action extracted in step S12.

The separation action search processing unit 321 searches the separation action table 332 of the knowledge DB server 3 and acquires the separation action that is coincident or similar to the separation action extracted in step S12 if present.

The FAQ creation processing unit 121 determines whether the separation action extracted in step S12 is coincident or similar to the separation action table 332 using the language model 4.

In a case where the separation action table 332 that is coincident or similar to the separation action extracted in step S12 is registered (YES in step S15), the FAQ creation processing unit 121 proceeds the process to step S16. On the other hand, in a case where the separation action table 332 that is coincident or similar to the separation action extracted in step S12 is not registered (NO in step S15), the FAQ creation processing unit 121 proceeds the process to step S17.

In step S16, the FAQ creation processing unit 121 acquires the Action name of the coincident or similar separation action table 332 registered in the separation action table 332 via the separation action search processing unit 321. On the other hand, in step S17, the FAQ creation processing unit 121 registers the separation action acquired in step S12 in the separation action table 332 of the knowledge DB server 3 via the separation action registration processing unit 322, and acquires the Action name. When step S16 or S17 ends, the process proceeds to step S18.

In step S18, the FAQ creation processing unit 121 extracts basic system information and symptoms from the ticket extracted in step S12 using the language model 4.

Next, in step S19, the FAQ creation processing unit 121 searches the FAQ table 331 to determine whether a similar FAQ having basic system information and symptoms similar or coincident to the basic system information and symptoms acquired in step S18 is present (registered).

That is, the FAQ creation processing unit 121 requests the FAQ search processing unit 323 of the knowledge DB program 32p to search for a similar FAQ.

The FAQ search processing unit 323 searches the FAQ table 331 of the knowledge DB server 3, and acquires a similar FAQ if present.

The FAQ creation processing unit 121 determines, using the language model 4, the coincidence between the basic system information and symptoms extracted in step S18 and the basic system information and symptoms in the FAQ table 331.

In a case where a similar FAQ is present (YES in step S19), the FAQ creation processing unit 121 proceeds the process to step S20. On the other hand, in a case where no similar FAQ is present (NO in step S19), the FAQ creation processing unit 121 proceeds the process to step S21.

In step S20, the FAQ creation processing unit 121 updates the FAQ table 331 by adding the separation action to the separation action group 331e of the similar FAQ via the FAQ registration processing unit 324 of the knowledge DB program 32p.

On the other hand, in step S21, the FAQ creation processing unit 121 newly creates the FAQ in the FAQ table 331 via the FAQ registration processing unit 324 of the knowledge DB program 32p. Then, the FAQ creation processing unit 121 adds the separation action to the separation action group 331e and updates the FAQ table 331.

The answer output processing unit 522 of the chat program 52p receives processing results of steps S20 and S21 from the FAQ creation processing unit 121, and outputs the received processing results as an answer 503c to an end user via the chat screen 502.

### FAQ Search Process According to Embodiment

FIG. 14 is a flowchart illustrating an FAQ search process according to the embodiment. The FAQ search process is executed by the FAQ search processing unit 122 of the incident response support system 1 when the end user who operates the user terminal 5 inputs the prompt 521p.

First, in step S31, the FAQ search processing unit 122 of the incident response support system 1 acquires search necessary information necessary for a similar FAQ search, for example, an acquisition symptom and basic system information, via the ticket information acquisition processing unit 221 and the work memo acquisition processing unit 222. The acquisition symptom and the basic system information are acquired from a ticket and a work memo of an incident whose cause and countermeasure are to be specified. Designation of the incident by the user is input to the prompt 502b via the prompt input processing unit 521 of the chat program 52p.

Next, in step S32, the FAQ search processing unit 122 refers to the FAQ table 331 via the FAQ search processing unit 323, and searches for a similar FAQ having a symptom and basic system information similar or coincident to the symptom and basic system information acquired in step S31. The FAQ search processing unit 122 determines whether the symptom and basic system information acquired in step S31 are coincident or similar to the symptom and basic system information in the FAQ table 331 using the language model 4.

Next, in step S33, the FAQ search processing unit 122 extracts a separation action from the similar FAQ acquired by the search in step S32 using the language model 4. Next, in step S34, the FAQ search processing unit 122 groups the FAQ acquired by the search in step S32 in which the separation action acquired in step S33 is coincident or similar using the language model 4, and sets a grouping result as the answer 502c. The grouping includes, for example, grouping the same commands or the same environment variables having different parameters into the same group. The FAQ search processing unit 122 outputs the grouping result as the answer 502c via the answer output processing unit 522 of the chat program 52p. As the grouping result, combinations of separation actions and FAQs are displayed in descending order of the executability. The user executes the confirmation procedure in descending order of the executability of the separation actions.

Next, in step S35, the FAQ search processing unit 122 receives an input of an execution result of the separation action. That is, a result of the user executing the confirmation procedure of the separation action having the highest executability among the separation actions presented to the user in step S34 is input to the prompt 502b via the prompt input processing unit 521 of the chat program 52p. By repeatedly executing step S35, the separation actions are sequentially executed in descending order of the executability.

Next, in step S36, the FAQ search processing unit 122 uses the language model 4 to identify the cause of the incident based on an execution result of the separation action input in step S35. That is, the FAQ search processing unit 122 uses the language model 4 to determine whether the execution result of the confirmation procedure included in the separation action executed by the user corresponds to the cause corresponding to the confirmation procedure in the separation action table 332, and determine that the cause can be identified when the execution result corresponds to the cause.

Next, in step S37, the FAQ search processing unit 122 determines whether the cause can be identified. In a case where the cause can be identified (YES in step S37), the FAQ search processing unit 122 outputs the cause 332d and the countermeasure 332e of the executed separation action as the answer 502c via an answer output processing unit 522p of the chat program 52p.

On the other hand, in a case where the cause cannot be identified (NO in step S37), the FAQ search processing unit 122 proceeds the process to step S38. In step S38, the FAQ search processing unit 122 filters the FAQ grouped in step S34 by a separation action of a confirmation procedure that the user has not executed and the execution result of step S35 has not been input. Then, the FAQ search processing unit 122 outputs the FAQ after the filtering again in descending order of the executability via the answer output processing unit 522p of the chat program 52p. That is, in the case where the cause cannot be identified, an FAQ related to a separation action for which the confirmation procedure has been executed by the user is deleted, and only an FAQ related to a separation action for which the confirmation procedure has not been executed by the user is output again. When step S38 ends, the FAQ search processing unit 122 proceeds the process to step S35 and receives an input of an execution result of the separation action having the highest executability.

### Incident Response Support Screen According to Embodiment

FIG. 15 is a diagram illustrating a configuration of the incident response support screen 500D according to the embodiment.

The incident response support screen 500D is displayed on a display screen of the user terminal 5. The incident response support screen 500D includes a ticket management screen 501, the chat screen 502, and a search result display screen 503.

The ticket management screen 501 includes a ticket list display region 501a and a ticket information display region 501b.

The ticket list display region 501a includes a filter condition setting region 5011a and a filter result display region 5011b. The ticket information display region 501b includes an ID display region 5012a, a title display region 5012b, a description display region 5012c, a conclusion display region 5012d, and a work memo display region 5012e.

A filter condition selected by the user is input to the filter condition setting region 5011a. The filter condition is designation of each item or a keyword included in each item such as the ticket ID 231a, the creation date and time 231b, and the creator 231c of the ticket information table 231. In the filter result display region 5011b, an ID or the like of the ticket information read from the ticket information table 231 stored in the ticket management server 2 as corresponding to the filter condition is displayed.

In the ID display region 5012a, the ID of the ticket information selected from the filter result display region 5011b by the user is displayed. The title of ticket information corresponding to the ID displayed in the ID display region 5012a is displayed in the title display region 5012b. In the description display region 5012c, a description of the ticket information corresponding to the ID displayed in the ID display region 5012a is displayed. In the conclusion display region 5012d, a conclusion of the ticket information corresponding to the ID displayed in the ID display region 5012a is displayed.

The chat screen 502 includes respective display regions of a use model selection region 502a, the prompt 502b, and the answer 502c. In the use model selection region 502a, selection of the language model 4 for generating an answer to a question input via a chat is received. The prompt 502b is an input format that receives a content of a question by the user and requests the language model 4 to generate an answer. The answer 502c is an answer to the prompt 502b generated by the language model 4.

The search result display screen 503 includes an FAQ search result display region 5031 and a separation action display region 5032. The FAQ search result display region 5031 displays a result of searching the FAQ table 331 of the knowledge DB server 3 according to the prompt 502b of the chat screen 502. The FAQ search result display region 5031 includes a selection check input region 503a, an FAQ name display region 503b, a symptom display region 503c, a basic system information display region 503d, and a separation action group display region 503e. In the selection check input region 503a, an FAQ selected from FAQ search results is checked. In the FAQ name display region 503b, the FAQ name 331a (FIG. 10) of the corresponding FAQ is displayed. In the basic system information display region 503d, the environment 331c and the configuration 331d (FIG. 10) of the corresponding FAQ are displayed. In the separation action group display region 503e, the separation action group 331e (FIG. 10) of the corresponding FAQ is displayed.

The separation action display region 5032 displays a list of separation actions included in the separation action group display region 503e included in the search result of the FAQ table 331 corresponding to the prompt 502b on the chat screen 502. The separation action display region 5032 includes an Action name display region 503f, a confirmation procedure display region 503g, an executability display region 503h, and a cause and countermeasure display region 503i. In the Action name display region 503f, the Action name 332a (FIG. 11) of the corresponding separation action is displayed. In the confirmation procedure display region 503g, the confirmation procedure 332b (FIG. 11) of the corresponding separation action is displayed. In the executability display region 503h, executability 332c (FIG. 11) of the corresponding separation action is displayed. In the cause and countermeasure display region 503i, the cause 332d and the countermeasure 332e (FIG. 11) of the corresponding separation action are displayed.

### FAQ Creation Process According to Embodiment

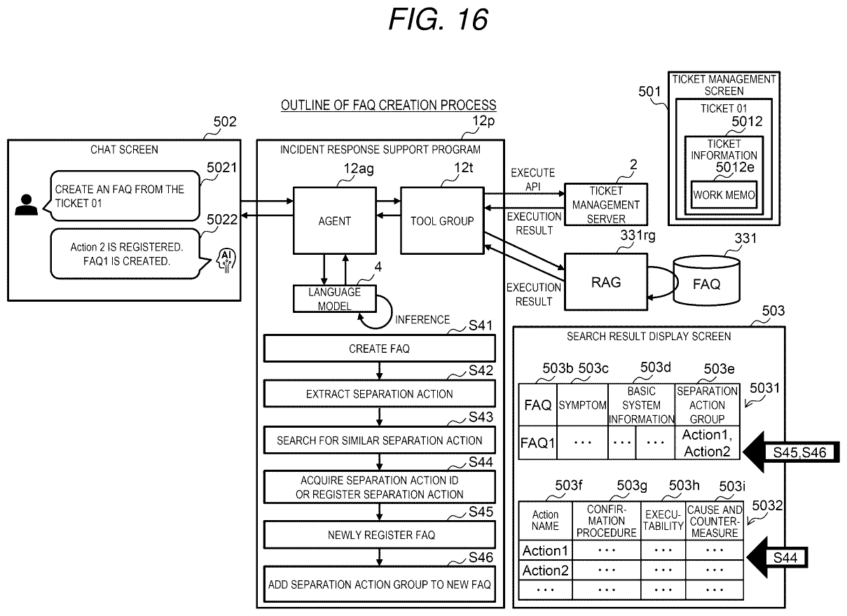

FIG. 16 is a diagram for illustrating an outline of an FAQ creation process according to the embodiment.

Step S41 illustrated in FIG. 16 corresponds to step S11 of the FAQ creation and update process (FIG. 13). Step S42 corresponds to step S12 of the FAQ creation and update process. Step S43 corresponds to step S15 of the FAQ creation and update process. Step S44 corresponds to steps S16 and S17 of the FAQ creation and update process. Steps S45 and S46 correspond to step S21 of the FAQ creation and update process.

Step S41 is executed in response to a creation instruction 5021 of the FAQ input from the chat screen 502. Then, data of a new separation action is registered in the separation action display region 5032 as an execution result of steps S42 to S44. An FAQ1 of the new FAQ is registered in the FAQ search result display region 5031 as an execution result of step S45. As an execution result of step S46, Action2 is registered in the separation action group display region 503e of the FAQ1, which is the new FAQ, in the FAQ search result display region 5031. In FIG. 16, as a final answer 5022, a notification of creation of the FAQ1 and addition of the Action2 is output to the chat screen 502.

### Outline of FAQ Search Process According to Embodiment

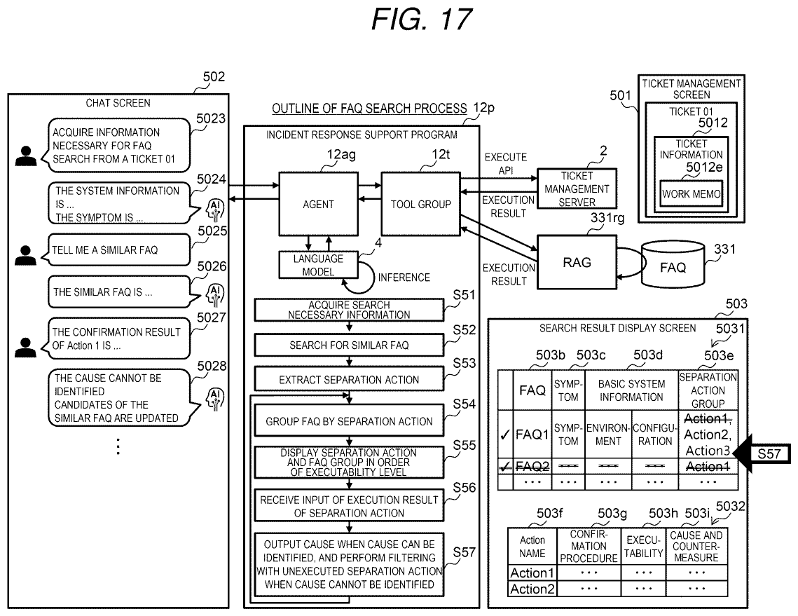

FIG. 17 is a diagram for illustrating an outline of the FAQ search process according to the embodiment.

Step S51 illustrated in FIG. 17 corresponds to step S31 of the FAQ search process (FIG. 14). Step S52 corresponds to step S32 of the FAQ search process. Step S53 corresponds to step S33 of the FAQ search process. Steps S54 and S55 correspond to step S34 of the FAQ search process. Step S57 corresponds to step S38 of the FAQ creation and update process.

Step S51 is executed in response to a necessary information acquisition instruction 5023 of the FAQ search input from the chat screen 502, and an answer 5024 is output to the chat screen 502. In addition, step S52 is executed in response to an execution instruction 5025 of a similar FAQ search input from the chat screen 502, and an answer 5026 is output to the chat screen 502.

Steps S56 and S57 are executed in response to an input of an execution result 5027 of Action1 from the chat screen 502. In FIG. 17, the chat screen 502 displays, a fact that the cause could not be identified in step S57 as a final answer 5028, and a fact that the similar FAQ displayed in the FAQ search result display region 5031 has been filtered with an unexecuted separation action. By this filtering, information related to the executed Action1 is deleted from the separation action group display region 503e.

### Outline of FAQ Update Process According to Embodiment

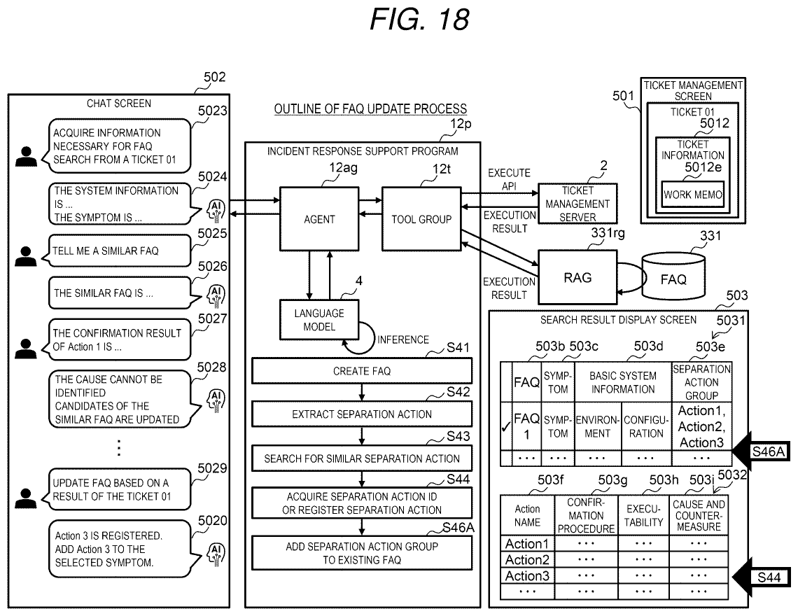

FIG. 18 is a diagram for illustrating an outline of the FAQ update process according to the embodiment.

As illustrated in FIG. 18, an FAQ update instruction 5029 is input following the output of the answer 5028 on the chat screen 502. Further, steps S41 to S44 are executed, and a separation action of Action3 is registered in the separation action display region 5032 as an execution result. Further, step S46A is executed, and the separation action of Action3 is registered in FAQ1 of the FAQ search result display region 5031 as an execution result. In FIG. 18, as a final answer 5020, a notification of registration of Action3 in the separation action display region 5032 and addition of Action3 to the symptom selected in the FAQ search result display region 5031 is output on the chat screen 502.

### Effects of Embodiment

In the above-described embodiment, the past case information (for example, the FAQ table 331) is searched based on the symptom and the system information of the target system as an input using the language model, and the past case (for example, FAQ) having coincident or similar symptom and system information is acquired. By using the language model, the past cases are grouped by the separation actions included in the acquired past cases, and the grouped past cases are output together with the separation actions. Therefore, according to the embodiment, it is possible to search for an FAQ under a wide range of conditions such as symptoms and system information, obtain a large number of search results, and easily narrow down the search results to a cause and countermeasure of interactive and inductive incidents through a chat with good predictability. That is, by displaying the searched past case information as a group based on the coincidence or similarity of the separation action, it is possible to improve the predictability of what is executed and how to separate the cause of the incident. By displaying the searched past case information as a group, for example, even in a case of the same commands or the same environment variables having different parameters, since the same confirmation procedure is performed, it is possible to collectively perform the determination of the executability, the execution, and the confirmation. In addition, even when the information necessary for the cause identification is not available only with the symptom that can be confirmed on a user side, the cause can be effectively narrowed down, and a time until the cause is identified can be shortened.

In the above-described embodiment, the execution result of the confirmation procedure included in the separation action by the user is received, and whether the execution result of the confirmation procedure corresponds to the cause corresponding to the confirmation procedure in the separation action information is determined using the language model. Then, the determined corresponding cause and the countermeasure corresponding to the cause in the separation action information is output. Therefore, according to the embodiment, it is possible to perform an efficient incident response by executing the confirmation procedure of the separation action inductively narrowed down through a chat interaction and outputting the cause and the countermeasure.

In the above-described embodiment, in a case where the cause cannot be identified, the past case related to the separation action for which the confirmation procedure has been executed by the user is deleted, and only the past case related to the separation action for which the confirmation procedure has not been executed by the user is output again. Therefore, according to the embodiment, it is possible to exclude the executed separation action for which the cause cannot be identified from the output display by filtering, and to continue the incident response with good predictability.

In the above-described embodiment, the symptom, the system information, the confirmation procedure, the cause, and the countermeasure are extracted from the work record related to the past case using the language model, and the extracted confirmation procedure is classified based on coincidence or similarity using the language model. Then, a separation action in which the classified confirmation procedure and the corresponding cause and countermeasure are combined is registered in the separation action information. In addition, a past case in which the extracted symptom, the system information, the confirmation procedure, and the separation action registered in the separation action information are combined is newly registered in the past case information. That is, a separation action is extracted in which similar duplication is excluded from the confirmation procedure among the solved ticket+the symptom extracted from the work memo+the system information+the confirmation procedure+the cause and countermeasure, and the past case information in which the separation action is associated with the past case is prepared. Therefore, according to the embodiment, it is possible to efficiently select and execute the confirmation procedure of the separation action for separating the cause of the incident based on the coincidence or similarity of the separation action.

In the above-described embodiment, in a case where the combination of the extracted symptom and the system information is already registered in the past case information, the separation action corresponding to the symptom and the system information is added to the separation action of the registered past case information to update the past case information. Therefore, according to the embodiment, it is possible to prevent the search accuracy from being reduced due to an increase of similar past cases (similar FAQs) by grouping past cases of various symptoms by the separation action.

In the above-described embodiment, the executability of the classified confirmation procedure is determined using the language model, and the classified confirmation procedure, the corresponding cause and countermeasure, and the determined executability of the confirmation procedure are combined and registered in the separation action information as the separation action. Therefore, according to the embodiment, it is possible to preferentially execute the confirmation procedure of the separation action having higher executability, and thus it is possible to efficiently search for the cause and the countermeasure.

In the above-described embodiment, the history of the input and output is recorded, and the additional information based on the history is added to the input when searching for the past case information. Therefore, according to the embodiment, the search accuracy of the similar past case can be improved.

Although some embodiments have been described above, these embodiments are examples for describing the present invention, and the scope of the present invention is not limited to these embodiments. The present invention can be implemented in various other forms, for example, a form in which a part of the configuration of each of the above-described embodiments is deleted, a form in which at least a part of the configuration is replaced, a form in which a configuration is added, and a form in which a part or all of the embodiments are combined.

What is claimed is:

1. An incident response support method executed by an incident response support system that supports identification of a cause of an incident occurred in a target system,
the incident response support system being configured to access
separation action information in which a combination of a confirmation procedure executed for the target system for identifying the cause of the incident, the cause, and a countermeasure against the incident is stored as a separation action, and
past case information in which a combination of a symptom of an incident occurred in a past system, system information indicating a configuration of the past system, and the separation action including the confirmation procedure executed for the past system in which the incident occurred is stored as a past case, and
the incident response support method comprising: respective processes of a processor of the incident response support system
searching for the past case information based on a symptom and system information of the target system as an input of a natural language using a language model for generating an output in response to the input, and acquiring the past case in which the symptom and the system information are coincident or similar;
grouping the past case by the separation action included in the acquired past case using the language model; and
outputting the grouped past case together with the separation action.

2. The incident response support method according to claim 1, further comprising: respective processes of the processor
receiving an execution result of the confirmation procedure included in the separation action by a user;
determining whether the execution result of the confirmation procedure corresponds to the cause corresponding to the confirmation procedure in the separation action information by using the language model; and
outputting the determined corresponding cause and the countermeasure corresponding to the cause in the separation action information.

3. The incident response support method according to claim 2, further comprising: a process of the processor
deleting, in a case where the cause cannot be identified, the past case related to the separation action for which the confirmation procedure is executed by the user, and re-outputting only the past case related to the separation action for which the confirmation procedure is not executed by the user.

4. The incident response support method according to claim 1, further comprising: respective processes of the processor
extracting the symptom, the system information, the confirmation procedure, the cause, and the countermeasure from a work record related to the past case by using the language model;
classifying the extracted confirmation procedure based on coincidence or similarity by using the language model;
registering, in the separation action information, the separation action in which the classified confirmation procedure and the corresponding cause and countermeasure are combined; and
newly registering, in the past case information, the past case in which the extracted symptom, the system information, the confirmation procedure, and the separation action registered in the separation action information are combined.

5. The incident response support method according to claim 4, further comprising: a process of the processor
updating, in a case where the combination of the extracted symptom and the system information is already registered in the past case information, the past case information by adding the separation action corresponding to the symptom and the system information to the separation action of the registered past case information.

6. The incident response support method according to claim 4, further comprising: respective processes of the processor
determining executability of the classified confirmation procedure by using the language model; and
registering the classified confirmation procedure, the corresponding cause and countermeasure, and the determined executability of the confirmation procedure in combination with each other in the separation action information as the separation action.

7. The incident response support method according to claim 1, wherein
the processor is configured to
record a history of the input and the output, and
add additional information based on the history to the input when searching for the past case information.

8. An incident response support system that supports identification of a cause of an incident occurred in a target system,
the incident response support system configured to access
separation action information in which a combination of a confirmation procedure executed for the target system for identifying a cause of the incident, the cause, and a countermeasure against the incident is stored as a separation action, and
past case information in which a combination of a symptom of an incident occurred in a past system, system information indicating a configuration of the past system, and the separation action including the confirmation procedure executed for the past system in which the incident occurred is stored as a past case, wherein
a processor of the incident response support system is configured to
search for the past case information based on a symptom and system information of the target system as an input of a natural language using a language model for generating an output in response to the input, and acquire the past case in which the symptom and the system information are coincident or similar,
group the past case by the separation action included in the acquired past case using the language model, and
output the grouped past case together with the separation action.
